(19) United States
(12) Patent Application Publication
(10) Pub. No.: US 2018/0355191 A1
(43) Pub. Date: Dec. 13, 2018

(54) METHOD FOR PRODUCING ELECTRO-CONDUCTIVE PASTE

(71) Applicant: HARIMA CHEMICALS, INC., Kakogawa-shi, Hyogo (JP)

(72) Inventor: Masayuki UEDA, Tsukuba-shi (JP)

(73) Assignee: HARIMA CHEMICALS, INC., Kakogawa-shi, Hyogo (JP)

(21) Appl. No.: 15/780,306

(22) PCT Filed: Dec. 3, 2015
(86) PCT No.: PCT/JP2015/084011

§ 371 Date: May 31, 2018

(51) Int. Cl. C09D 5/24; B22F 1/00; B22F 1/02; B22F 9/30; B22F 9/20; C09D 7/40; C09D 7/62; H01B 1/22; H01B 13/00

(52) U.S. Cl. CPC C09D 5/24; B22F 1/0022; B22F 1/02; B22F 9/30; B22F 9/20; B22F 2304/054; C09D 7/62; H01B 1/22; H01B 13/0036; B22F 2301/255; C09D 7/67

(57) ABSTRACT

Provided is an electro-conductive paste suitable to yield a sintered metal fine particulate layer having excellent adhesion to an ITO substrate. Powdery silver oxide is dispersed in a non-polar solvent. An excess amount of formic acid is added to allow the formic acid to react with the powdery silver oxide to thereby convert the powdery silver oxide into powdery silver formate (HCOOAg). A primary amine is allowed to react with the powdery silver formate to provide a primary amine addition salt of the silver formate, and the primary amine addition salt of the silver formate is subjected to a decompositional reduction reaction at a liquid temperature of around 70° C. to generate silver nanoparticles having a coating layer including the primary amine. To the resulting silver nanoparticle dispersion liquid, more than 0 parts by mass and 2.0 parts by mass or less of a titanium compound or manganese compound is added per 100 parts by mass of silver.

### TECHNICAL FIELD

The present invention relates to a method for producing an electro-conductive paste that can be suitably used to form an electro-conductive thin film on an electro-conductive indium tin oxide (ITO) substrate.

### BACKGROUND ART

Electro-conductive ITO films are used as light transmissive electrode layers in liquid crystal display apparatuses for flat displays and the like.

Patent Literature 1 discloses a method by which a fine pattern of a metal thin film having excellent adhesion to a surface of an electro-conductive ITO film can be produced with a high drawing accuracy, workability, and reproducibility. In this method, a solution of a transition metal compound containing organic anion species and transition metal cation species dissolved in an organic solvent is applied to an ITO film and the surface of a glass substrate as the base substrate. Then the applied solution is heat-treated to form a transition metal thin film layer. To a surface of the transition metal thin film, a dispersion liquid of metal fine particulates having an average particle size in the range of 1 to 100 nm is applied at a predetermined film thickness. Then, the layer of the metal fine particulates sintered to one another is formed by heating and firing in order to obtain the fine pattern of the metal thin film having excellent adhesion. That is, by priming the electro-conductive ITO film before the metal thin film pattern is formed with the electro-conductive paste, adhesion between the metal thin film pattern formed with the electro-conductive paste and the electro-conductive ITO film is enhanced.

Patent Literature 2 discloses an electro-conductive metal paste suitable for forming sintered metal fine particulate layers having good adhesion to glass substrates.

Patent Literature 3 discloses a method for preparing a dispersion liquid of silver nanoparticles having a surface coating layer including an amine compound by using silver oxide as a raw material and by means of reduction reaction in a liquid phase.

### PRIOR ART LITERATURES

### Patent Literature

Patent Literature 1: JP 2005-293937A

Patent Literature 2: WO 2006/011180 A1

Patent Literature 3: JP 2005-293937A

### SUMMARY OF INVENTION

### Problems to be Solved by the Invention

According to Patent Literature 1, an electro-conductive paste can be used to form a metal thin film pattern having a good adhesion to an ITO film. However, this method requires priming. From the viewpoint of reduction of the number of the steps, elimination of priming is desired.

It cannot be said that the electro-conductive metal pastes described in Patent Literatures 2 and 3 are suitable for obtaining a sintered metal fine particulate layer having excellent adhesion to a substrate including ITO.

It is an object of the present invention to provide an electro-conductive paste suitable for obtaining a sintered metal fine particulate layer having excellent adhesion to a substrate including ITO.

### Means for Solving the Problems

According to an aspect of the present invention, there is provided a method for producing an electro-conductive paste including:

A) a step of preparing silver nanoparticles having an average particle size of 5 nm to 20 nm, the silver nanoparticles having a coating layer comprising coating agent molecules on the surface,

the step of preparing silver nanoparticles being a step in which powdery silver(I) oxide is used as a raw material, in a liquid phase, formic acid is allowed to react with the powdery silver(I) oxide to convert the powdery silver(I) oxide into silver(I) formate, silver cations contained in the silver(I) formate are reduced to silver atoms, and

the silver nanoparticles are prepared from the silver atoms; and

the step of preparing silver nanoparticles comprising

Step i:

a step of preparing a dispersion liquid of the powdery silver(I) oxide using a hydrocarbon solvent;

Step ii:

a step of adding formic acid to the dispersion liquid of the powdery silver(I) oxide to allow formic acid to react with the powdery silver(I) oxide to thereby convert the powdery silver(I) oxide into silver(I) formate, and

preparing a dispersion liquid of powdery silver(I) formate containing powder of silver(I) formate formed in the hydrocarbon solvent; and

Step iii:

a step of adding a primary amine to the dispersion liquid of the powdery silver(I) formate to allow the primary amine to react with the powdery silver(I) formate to thereby form a primary amine complex of the silver(I) formate,

dissolving the formed primary amine complex of the silver(I) formate in the hydrocarbon solvent, and then,

forming silver nanoparticles having an average particle size of 5 nm to 20 nm comprising silver atoms by a decompositional reduction reaction of the primary amine complex of the silver(I) formate,

wherein the silver nanoparticles having an average particle size of 5 nm to 20 nm formed in the step iii have a structure in which silver atoms on the surface of the silver nanoparticles are coated with the primary amine via coordination bonding by means of the lone electron pair present on the amino nitrogen atom of the primary amine; and

B) a step of adding one or more metal compounds selected from the group consisting of a titanium compound and a manganese compound to the dispersion liquid of the silver nanoparticles obtained from the step A, metal contained in the metal compound being in an amount of more than 0 part by mass and 2.0 parts by mass or less based on 100 parts by mass of silver contained in the dispersion of the silver nanoparticles obtained from the step A.

It is preferred that the titanium compound be one or more selected from the group consisting of alkoxy titanium, carboxy titanium, and titanium acetyl acetonate and the manganese compound be one or more selected from the group consisting of carboxy manganese and manganese acetyl acetonate.

It is preferred that the amount of the metal contained in the metal compound added in the step B be 0.5 to 2 parts by mass based on 100 parts by mass of silver contained in the dispersion liquid of the silver nanoparticles obtained from the step A.

The amount of the hydrocarbon solvent used in the step i is preferably selected in the range of 350 parts by mass to 550 parts by mass per 100 parts by mass of the powdery silver(I) oxide as the raw material. Also, the boiling point of the hydrocarbon solvent is preferably in the range of 65° C. to 155° C. The hydrocarbon solvent may be a chain hydrocarbon solvent or may be a cyclic hydrocarbon solvent.

The hydrocarbon solvent used in the step i is preferably a hydrocarbon having 6 to 9 carbon atoms.

The amount of the formic acid used in step ii is preferably selected in the range of 1.1 molar amount to 1.4 molar amount per 1 molar amount of the silver cation contained in the powdery silver(I) oxide as the raw material.

In the step iii, a monocarboxylic acid having 8 to 11 carbon atoms can be added.

In the step iii, it is possible to use a primary amine having 9 to 11 carbon atoms as the primary amine and to add a secondary amine.

The amount of the primary amine used in step iii is preferably selected in the range of 1.2 molar amount to 1.8 molar amount per 1 molar amount of the silver cation contained in the powdery silver(I) oxide as the raw material. Additionally, the primary amine is preferably a primary amine (R—NH₂) including an amino group and an atomic group R having an aliphatic hydrocarbon chain having compatibility with the hydrocarbon solvent.

Meanwhile, in the primary amine (R—NH₂) including the amino group and the atomic group R having the aliphatic hydrocarbon chain having compatibility with the hydrocarbon solvent,

the atomic group R having the aliphatic hydrocarbon chain having compatibility with the hydrocarbon solvent is preferably selected from an (alkyloxy)alkyl group, an (alkylamino)alkyl group, a (dialkylamino)alkyl group and an alkyl group having 7 to 12 carbon atoms in total.

The primary amine (R—NH₂) including the amino group and the atomic group R having the aliphatic hydrocarbon chain having compatibility with the hydrocarbon solvent is preferably an amine compound having a boiling point more than 170° C. Furthermore, the primary amine (R—NH₂) including the amino group and the atomic group R having the aliphatic hydrocarbon chain having compatibility with the hydrocarbon solvent is more preferably an amine compound having a boiling point in the range of 200° C. to 270° C.

For example, it is possible to suitably select an aspect in which the primary amine (R—NH₂) including the amino group and the atomic group R having the aliphatic hydrocarbon chain having compatibility with the hydrocarbon solvent is 3-alkyloxypropylamine (R′—O—CH₂CH₂CH₂—NH₂) and

the alkyl group (R′) constituting the alkyloxy atomic group (R′—O—) is an alkyl group having 4 to 9 carbon atoms.

It is possible to suitably select an aspect in which the primary amine (R—NH₂) including the amino group and the atomic group R having the aliphatic hydrocarbon chain having compatibility with the hydrocarbon solvent is 3-(dialkylamino)propylamine (R¹N(R²)—CH₂CH₂CH₂—NH₂) and

the alkyl groups (R¹ and R²) constituting the dialkylamino atomic group (R¹N(R²)—) have 4 to 9 carbon atoms in total.

It is desirable to select an aspect in which, in the step iii, a primary amine (R—NH₂) including an amino group and an atomic group R having an aliphatic hydrocarbon chain having compatibility with an hydrocarbon solvent is diluted using the hydrocarbon solvent to provide a diluted solution, which is then added to the dispersion liquid of the powdery silver(I) formate, and

the diluted solution is subjected to the dilution by adding the hydrocarbon solvent in an amount in the range of 20 parts by mass to 45 parts by mass per 100 parts by mass of the primary amine.

Usually, it is desirable to select an embodiment in which, in the step iii,

in parallel with the reaction in which the primary amine reacts with the powdery silver(I) formate to form the primary amine complex of the silver(I) formate,

there proceeds a reaction in which the added primary amine reacts with residual formic acid that has not been consumed in the reaction with the powdery silver(I) oxide in the step ii, to form the primary amine addition salt of the formic acid, and

the liquid temperature is raised by reaction heat ascribed to the reaction of forming the primary amine addition salt of the formic acid.

Furthermore,

it is preferred to employ an embodiment in which the step A further includes the following steps iv to vi after the step iii.

Step iv:

a step of distilling the hydrocarbon solvent off under reduced pressure after the step iii is finished, the hydrocarbon solvent being contained in the reaction liquid containing the silver nanoparticles having an average particle size of 5 nm to 20 nm, the surface of the silver nanoparticles being coated with the primary amine, and

recovering a residue containing residual primary amine, a primary amine addition salt of the formic acid, and the silver nanoparticles having an average particle size of 5 nm to 20 nm, the surface of the silver nanoparticles being coated with the primary amine;

Step v:

a step of adding to the residue recovered in the step iv methanol in an amount selected in the range of 200 parts by mass to 300 parts by mass and distilled water in an amount selected in the range of 50 parts by mass to 300 parts by mass per 100 parts by mass of the powdery silver(I) oxide as the raw material,

dissolving the primary amine addition salt of the formic acid and the residual primary amine contained in the residue in the mixed solvent of methanol and distilled water,

separating a resulting mixture into a precipitate layer containing the silver nanoparticles having an average particle size of 5 nm to 20 nm, the surface of the silver nanoparticles being coated with the primary amine, and a liquid phase layer containing the primary amine addition salt of the formic acid and primary amine dissolved in the mixed solvent, and

removing the liquid phase layer containing the primary amine addition salt of the formic acid and the primary amine dissolved in the mixed solvent to recover a precipitate layer containing the silver nanoparticles having an average particle size of 5 nm to 20 nm, the surface of the silver nanoparticles being coated with the primary amine;

Step vi:

a step of adding a hydrocarbon solvent having a boiling point in the range of 65° C. to 155° C. in an amount selected in the range of 100 parts by mass to 200 parts by mass per 100 parts by mass of the powdery silver(I) oxide as the raw material to the precipitate layer recovered in the step v,

homogeneously dispersing the silver nanoparticles having an average particle size of 5 nm to 20 nm, the surface of the silver nanoparticles being coated with the primary amine, contained in the precipitate layer in the hydrocarbon solvent having a boiling point in the range of 65° C. to 155° C. to obtain a dispersion liquid,

separating the dispersion liquid into a layer of a small amount of the mixed solvent of methanol and distilled water with which the precipitate layer has been impregnated and a layer of a dispersion liquid containing the hydrocarbon solvent having a boiling point in the range of 65° C. to 155° C. as a dispersion solvent, and

removing the layer of the small amount of the mixed solvent of methanol and distilled water to recover the layer of the dispersion liquid containing the hydrocarbon solvent having a boiling point in the range of 65° C. to 155° C. as the dispersion solvent.

Silver nanoparticles prepared by use of the aforementioned method for preparing silver nanoparticles according to the present invention are silver nanoparticles which have an average particle size of 5 nm to 20 nm, and which have, on the surface, a coating layer including a primary amine having an aliphatic hydrocarbon chain having compatibility with the hydrocarbon solvent. Thus, the silver nanoparticles can be stored in the form of a dispersion liquid in the hydrocarbon solvent.

### Advantages of the Invention

According to the present invention, there is provided an electro-conductive paste suitable for obtaining a sintered metal fine particulate layer having excellent adhesion to a substrate including ITO.

### Embodiments for Carrying Out the Invention

Embodiments of the present invention will be described in more detail below, but the present invention is not restricted thereby. The sintered metal fine particulates formed by using the electro-conductive paste of the present invention have excellent adhesion not only to ITO but also to glass.

(Terms)

The average particle size herein refers to a particle diameter at which the cumulative value is 50% in the particle size distribution (on a volume basis) measured by the laser diffraction method.

The term “boiling point” means the boiling point at 1 atm.

The term “ink” means a paste particularly suitable for printing.

In the case where the amount (mass or content) of silver nanoparticles is referred to, the amount means the amount of the silver nanoparticles only (thus, including no coating agent), unless otherwise indicated. Meanwhile, in the case where the particle diameter of silver nanoparticles is referred to, the particle diameter means a particle diameter including the coating agent adhering to the surface of the silver nanoparticles, unless otherwise indicated.

(Step A)

Step A, that is, a step of preparing silver nanoparticles has the following step i to step iii.

(Step i) Preparation of dispersion liquid of powdery silver(I) oxide:

In the present invention, powdery silver(I) oxide (Ag₂O; formula weight: 231.74, density: 7.22 g/cm³) is used as a starting material. The powdery silver(I) oxide does not dissolve in non-polar solvents, for example, chain hydrocarbon solvents. When the powdery silver(I) oxide is brought into a fine powder form, the fine powder can be homogeneously dispersed in non-polar solvents, for example, chain hydrocarbon solvents. Specifically, in order to prepare a homogeneous dispersion liquid, powdery silver(I) oxide having a particle size distribution within the range of 200 mesh or less (75 μm or less) is suitably used.

In the present invention, the dispersion solvent for powdery silver(I) oxide is also used as a solvent for dissolving a primary amine. Accordingly, as the dispersion solvent for powdery silver(I) oxide, a hydrocarbon solvent is used. In a step of recovering and separating the prepared silver nanoparticles from a reaction liquid, as described below, the dispersion solvent contained in the reaction liquid is removed by distillation-off under reduced pressure. A hydrocarbon solvent is selected so that the solvent exhibits boiling and dissipation properties which enable the solvent to be distilled off under such reduced pressure. Thus, in the present invention, a hydrocarbon solvent having a boiling point in the range of 65° C. to 155° C., preferably in the range of 80° C. to 130° C. is selected as the dispersion solvent for powdery silver(I) oxide. For example, as the dispersion solvent for powdery silver(I) oxide, a hydrocarbon (e.g., an alkane) having 6 to 9 carbon atoms is preferably used. Linear alkanes having 6 to 9 carbon atoms, for example, hexane (boiling point: 68.74° C., density: 0.6603 g/cm³), heptane (boiling point: 98.42° C., density: 0.684 g/cm³), octane (boiling point: 125.67° C., density: 0.7026 g/cm³), and nonane (boiling point: 150.8° C., density: 0.7 g/cm³) can be used. Amongst them, linear alkanes having 6 to 9 carbon atoms are desirably used. Particularly, alkanes having a boiling point in the range of 80° C. to 100° C., for example, a linear alkane having a boiling point in the range of 80° C. to 100° C., that is, heptane (boiling point: 98.42° C., density: 0.684 g/cm³) or the like is more desirably used. As the dispersion solvent for powdery silver(I) oxide, cycloalkanes such as methylcyclohexane (boiling point: 100.9° C.) may be used. Alternatively, cyclic alkenes such as toluene may be used.

For example, in the case where a hydrocarbon solvent having a boiling point lower than the boiling point of formic acid (100.75° C.), particularly an alkane having a boiling point in the range of 80° C. to 100° C. is selected, when the temperature of the reaction liquid rises in association with heat generation in the below-mentioned formation reaction of powdery silver(I) formate, this temperature does not exceed the boiling point of the hydrocarbon solvent. Thus, boiling and dissipation of formic acid can be suppressed. Also in a separation step described below, an alkane having a boiling point in the range of 80° C. to 100° C. is more preferably used when the hydrocarbon solvent is distilled off under reduced pressure, from the viewpoint of workability.

By use of a hydrocarbon solvent in an amount selected in the range of 350 parts by mass to 550 parts by mass, preferably in the range of 350 parts by mass to 500 parts by mass, more preferably in the range of 400 parts by mass to 500 parts by mass per 100 parts by mass of the powdery silver(I) oxide as the raw material, the dispersion liquid of the powdery silver(I) oxide can be prepared. By use of a hydrocarbon solvent having a boiling point in the range of 65° C. to 155° C., preferably in the range of 80° C. to 130° C., the dispersion liquid of the powdery silver(I) oxide can be prepared.

(Step ii) Preparation of Dispersion Liquid of Powdery Silver(I) Formate:

In the present invention, formic acid (HCOOH; formula weight 46.025, boiling point: 100.75° C.) is allowed to react with powdery silver(I) oxide (Ag₂O) in the dispersion liquid to convert the powdery silver(I) oxide into silver(I) formate (HCOOAg).

Formic acid (HCOOH) associates by hydrogen bonding to form dimers (HCOOH:HOOCH). Even in the hydrocarbon solvent, the major portion of the formic acid molecules is dissolved in the form of dimers. Accordingly, dimers of formic acid (HCOOH:HOOCH) react with the powdery silver(I) oxide (Ag₂O) in the dispersion liquid to generate silver(I) formate (HCOOAg) in accordance with the reaction represented by the following formula (i).

Ag^{I}₂O+(HCOOH:HOOCH)→2[(HCOO⁻) (Ag^{I})⁺]+H₂O Formula (i)

Generated Silver(I) formate (HCOOAg) has extremely low solubility in hydrocarbon solvents, and therefore, forms an aggregate [(HCOO⁻) (Ag^{I})⁺] and is dispersed in the hydrocarbon solvent.

The reaction represented by the above formula (i) corresponds to a “neutralization reaction” between silver(I) oxide (Ag₂O), which is a basic metal oxide, and a dimer of formic acid (HCOOH:HOOCH). This reaction is an exothermic reaction. By selecting the proportion of the amount of the dispersion solvent with respect to the powdery silver(I) oxide (Ag₂O) within the above-mentioned range, it is possible to suppress an increase in the temperature of the entire dispersion liquid up to around 40° C. That is, it is possible to suppress an excess increase in the liquid temperature, and to prevent formic acid, which has a function as a reducing agent, from reacting with the generated silver(I) formate (HCOOAg). Thus, it is possible to prevent the reduction reaction represented by the following formula (A1) from proceeding. It is also possible to prevent the decompositional reduction reaction of the generated silver(I) formate (HCOOAg) represented by the following formula (A2) from proceeding.

2[(HCOO⁻)(Ag^{I})⁺]+HCOOH→2Ag+2HCOOH+CO₂↑ Formula (A1)

2[(HCOO⁻)(Ag^{I})⁺]→2Ag+HCOOH+CO₂↑ Formula (A2)

In order to carry out the reaction of the above formula (i), formic acid is added in an amount selected from preferably in the range of 1.1 molar amount to 1.4 molar amount, more preferably in the range of 1.2 molar amount to 1.3 molar amount per 1 molar amount of the silver cation contained in the powdery silver(I) oxide as the raw material. Addition of an excess amount of formic acid enables the powdery silver(I) oxide as the raw material to be entirely converted into silver(I) formate (HCOOAg). As a result, a dispersion liquid of the aggregate of [(HCOO⁻) (Ag^{I})⁺] can be obtained.

It is presumed that the major portion of water molecules (H₂O) byproduced in the reaction of the above formula (i) is incorporated in the generated aggregate of [(HCOO⁻) (Ag^{I})⁺] in the form of “water of crystallization”. Specifically, it is presumed that the reaction of the formula (i) possibly proceeds by means of two elementary processes of the following (i-1) and (i-2). Consequently, it is presumed that the byproduced water molecules (H₂O) solvates the generated [(HCOO⁻) (Ag^{I})⁺] and the major portion of the water molecules is incorporated in the generated aggregate of [(HCOO⁻) (Ag^{I})⁺] in the form of “water of crystallization”.

Ag₂O +(HCOOH:HOOCH)→[HCOO Ag:AgOH:HOOCH] (i-1)

[HCOO Ag:(HO)Ag:HOOCH]→[(HCOO⁻)(Ag¹)⁺](H₂O)[⁺(Ag¹)(—OOCH)] (i-2)

Addition of an excess amount of formic acid results in residual unreacted formic acid, which is dissolved in the hydrocarbon solvent as dimers of formic acid (HCOOH:HOOCH).

(Step iii) Formation of Primary Amine Complex of Silver(I) Formate and Decompositional Reduction Reaction:

After step ii is finished, when the liquid temperature decreases to 30° C., a primary amine (R—NH₂), which has an aliphatic hydrocarbon chain having compatibility with the hydrocarbon solvent, may be added to the dispersion liquid of the aggregate of [(HCOO⁻) (Ag^{I})⁺] to allow the primary amine (R—NH₂) to react with [(HCOO⁻) (Ag^{I})⁺] which forms the aggregate. That is, a primary amine complex (HCOOAg:NH₂—R) of the silver(I) formate (HCOOAg) is generated by the reaction represented by the following formula (ii).

2[(HCOO⁻)(Ag^{I})⁺]+2R—NH₂→2[(HCOO⁻)(Ag^{I})⁺:NH₂—R] Formula (ii)

The generated primary amine complex (HCOOAg:NH₂—R) of the silver(I) formate (HCOOAg), in which atomic group R of the primary amine (R—NH₂) moiety has an aliphatic hydrocarbon chain having compatibility with the hydrocarbon solvent, dissolves in the hydrocarbon solvent. Specifically, it is presumed that the reaction of the formula (ii) possibly proceeds by means of two elementary processes of the following (ii-1) and (ii-2).

[HCOOAg](H₂O)[AgOOCH]+R—NH₂→[R—NH₂:Ag⁺⁻OCHO](H₂O)[AgOOCH] (ii-1)

[R—NH₂:Ag⁺⁻O—CHO](H₂O)[AgOOCH]+R—NH₂→[R—NH₂:Ag⁺⁻O—CHO](H₂O)[HCOO⁻⁺Ag:NH₂—R]

Silver(I) formate (HCOOAg) in the aggregate incorporates water molecules (H₂O) in the form of “water of crystallization” and forms a structure of [HCOOAg] (H₂O) [AgOOCH]. When the primary amine (R—NH₂) reacts with the silver(I) formate (HCOOAg) to be placed on the silver cations ((Ag^{I})⁺), the silver(I) formate (HCOOAg) is converted to a primary amine complex (HCOOAg:NH₂—R). In this case, water molecules (H₂O), which are incorporated in the form of “water of crystallization”, go into a state of “solvation” in formic acid anion species (⁻O—CHO) moiety of the primary amine complex (HCOOAg:NH₂—R). Specifically, it is presumed that hydrogen bonding is formed between two formic acid anion species (^{-O}—CHO), and that water molecules (H₂O) go into a “solvation” state; ⁻O—CHO.H—(HO).H—COO⁻. Accordingly, it is presumed that a primary amine complex of the generated silver(I) formate (HCOOAg) is, after all, dissolved in the hydrocarbon solvent in the state in which the above water molecules (H₂O) are “solvated”.

Meanwhile, unreacted formic acid remaining in the dispersion liquid is dissolved as dimers of the formic acid (HCOOH:HOOCH) in the hydrocarbon solvent. When the primary amine (R—NH₂) is added to the hydrocarbon solvent, the primary amine (R—NH₂) reacts also with the dimers of the formic acid (HCOOH:HOOCH). That is, the reaction represented by the following formula (iii) generates the primary amine addition salt of formic acid (HCOOH:NH₂—R).

(HCOOH:HOOCH)+2R—NH₂→2(R—NH₂:HOOCH) Formula (iii)

The formation reaction of the primary amine addition salt of formic acid, which is represented by formula (iii), corresponds to a “neutralization reaction” of acid/base. This reaction is an exothermic reaction. The generated primary amine addition salt (HCOOH:NH₂—R) of the formic acid, in which atomic group R of the primary amine (R—NH₂) moiety has an aliphatic hydrocarbon chain having compatibility with the hydrocarbon solvent, dissolves in the hydrocarbon solvent. The temperature of the reaction liquid rises as the formation reaction of the primary amine addition salt of the formic acid, represented by formula (iii), proceeds. When the temperature of the reaction liquid becomes closer to the boiling point of the hydrocarbon solvent, boiling and dissipation of the hydrocarbon solvent begins, thus, the temperature of the reaction liquid does not exceed the boiling point of the hydrocarbon solvent.

As the liquid temperature increases, the decompositional reduction reaction represented by the following formula (iv) of the primary amine complex (HCOOAg:NH₂—R)of silver(I) formate (HCOOAg) is started. The decompositional reduction reaction represented by the formula (iv), which is an endothermic reaction, does not substantially proceed until the temperature of the reaction liquid reaches a certain temperature.

2(R—NH₂:Ag—OOCH)→2[R—NH₂:Ag]+HCOOH+CO₂↑ Formula (iv)

It is presumed that the decompositional reduction reaction represented by the formula (iv) possibly proceeds by means of two elementary processes of the following (iv-1) and (iv-2).

[R—NH₂:Ag⁺⁻O—CHO](H₂O)[HCOO⁻⁺Ag:NH₂—R]→(R—NH₂:Ag)+O═CHOH+[HO.H.COO⁻⁺Ag:NH₂—R] (iv-1)

[HO.H.COO⁻⁺Ag:NH₂—R]→[HOH.COO]+(Ag:NH₂—R)→(Ag:NH₂—R)+H₂O+CO₂↑ (iv-2)

Carbon oxide (CO₂) derived from the decompositional reduction reaction represented by the formula (iv) forms bubbles, and thus, bubbles are observed in the reaction liquid. Byproduced formic acid (HCOOH) once forms dimers of formic acid (HCOOH:HOOCH), and then is converted, together with the primary amine dissolved in reaction liquid, into the primary amine addition salt of the formic acid (HCOOH:NH₂—R) by the reaction represented by the above formula (iii).

Meanwhile, metal silver atoms [Ag:NH₂—R], which are generated by the decompositional reduction reaction represented by the formula (iv), aggregate to form aggregates of the metal silver atoms. At this time, concomitantly with the formation of the aggregates of the metal silver atoms, a portion of primary amine (R—NH₂) coordinated to the metal silver atoms is thermally dissociated. Accordingly, the formed aggregates of the metal silver atoms become silver nanoparticles, each of which includs a spherical core constituted by metal atoms and a coating agent molecule layer with which the surface of the core is coated, the layer being constituted by the primary amine (R—NH₂).

The thermally dissociated primary amine (R—NH₂) is used in the generation reaction of the primary amine complex (HCOOAg:NH₂—R) of the silver(I) formate (HCOOAg) of the above formula (ii) and the formation reaction of the primary amine addition salt of formic acid of the formula (iii).

When the step ii is completed, by adjusting the amount of the remaining unreacted formic acid, the amount of the primary amine to be added and the amount of the entire reaction liquid, it is possible to prevent the liquid temperature of the reaction liquid from rising up to 70° C. or more.

When an excess amount of the primary amine (R—NH₂) is present in the reaction liquid, the formation reaction the primary amine addition salt of the formic acid of the above formula (iii) proceeds, and therefore, the concentration of the dimers of the formic acid (HCOOH:HOOCH) dissolved in the reaction liquid is maintained at a low level. Accordingly, the formic acid, which has a function as a reducing agent, can acts to prevent the reduction reaction that can be represented by the above formula (A1) from proceeding.

When the liquid temperature of the reaction liquid is prevented from rising up to 70° C. or more, the generation reaction of the primary amine complex (HCOOAg:NH₂—R) of the silver(I) formate (HCOOAg) of the above formula (ii) preferentially proceeds. It is thus possible to avoid the decompositional reaction of the silver(I) formate, which reaction can be represented by the above formula (A2), from proceeding.

The primary amine (R—NH₂) having an aliphatic hydrocarbon chain having compatibility with the hydrocarbon solvent is used in the formation reaction of the primary amine addition salt of the formic acid of the above formula (iii) and in the formation reaction of the primary amine complex of the silver(I) formate of the formula (ii). Examples of the atomic group R include a chain hydrocarbon group having 7 to 12 carbon atoms such as an alkyl group having 7 to 12 carbon atoms, an (alkyloxy)alkyl group having 7 to 12 carbon atoms in total, and an (alkylamino)alkyl group and a (dialkylamino)alkyl groups having 7 to 12 carbon atoms in total. For example, it is possible to suitably use a compound in which the primary amine (R—NH₂) is 3-alkyloxypropylamine (R′—O—CH₂CH₂CH₂—NH₂), and in which the alkyl group (R′) constituting the alkyloxy atomic group (R′—O—) is an alkyl group having 4 to 9 carbon atoms, more preferably an alkyl group having 6 to 8 carbon atoms.

It is also possible to uses a compound in which the primary amine (R—NH₂) is 3-(dialkylamino)propylamine (R¹N(R₂)—CH₂CH₂CH₂—NH₂) and the alkyl groups (R¹ and R₂) constituting the dialkylamino atomic group (R¹N(R₂)—) have 4 to 9 carbon atoms in total.

Meanwhile, the primary amine (R—NH₂) is used as the coating agent molecule with which the surface of the silver nanoparticles is coated. Therefore, the primary amine (R—NH₂) is preferably an amine compound having a boiling point higher than 170° C., more preferably an amine compound having a boiling point in the range of 200° C. to 270° C. For example, 3-(alkyloxy)propylamine (R′—O—CH₂CH₂CH₂—NH₂) and 3-(dialkylamino)propylamine (R″R′N—CH₂CH₂CH₂—NH₂) having a boiling point in the range of 200° C. to 270° C., such as 2-ethylhexyloxypropylamine (boiling point: 235° C.) having a 2-ethylhexyl group as an alkyl group having 8 carbon atoms and dibuthylaminopropylamine (boiling point: 238° C.) having a dibuthylaminopropyl group can be suitably used as the primary amine (R—NH₂) having an aliphatic hydrocarbon chain having compatibility with the hydrocarbon solvent.

The addition amount of the primary amine (R—NH₂) having an aliphatic hydrocarbon chain having compatibility with the hydrocarbon solvent is preferably selected in the range of 1.2 molar amount to 1.8 molar amount, more preferably the range of 1.3 molar amount to 1.6 molar amount per 1 molar amount of the silver cation contained in the powdery silver(I) oxide as the raw material.

Accordingly, the molar amount of the primary amine (R—NH₂) to be added is selected so as to exceed the molar amount of formic acid (HCOOH) added in the step ii. It is desirable that the ratio of the molar amount of the primary amine (R—NH₂) added in the step iii to the molar amount of the formic acid (HCOOH) added in the step ii [primary amine/formic acid] be selected preferably in the range of 1.2/1.1 to 1.8/1.4, more preferably in the range of 1.3/1.1 to 1.6/1.3, still more preferably in the range of 1.4/1.2 to 1.6/1.3.

The atomic group R in the primary amine (R—NH₂) has an (alkyloxy)alkyl group, an (alkylamino)alkyl group, a (dialkylamino)alkyl group or an alkyl group having 7 to 12 carbon atoms in total. As the total number of carbon atoms in the atomic group R increases, the melting point and the boiling point rise. Thus, the primary amine may be solid at room temperature. Alternatively, the primary amine may be liquid, but the liquidity is not high. Considering this point, the primary amine (R—NH₂) is preferably added in the form of a solution in which the amine is dissolved in a hydrocarbon solvent. That is, the primary amine is diluted using a hydrocarbon solvent having a boiling point preferably in the range of 65° C. to 155° C., more preferably in the range of 80° C. to 130° C., to provide a diluted solution, which is then added to the dispersion liquid of the powdery silver(I) formate. In this case, the diluted solution has been desirably diluted by adding a hydrocarbon solvent having a boiling point in the range of 65° C. to 155° C., preferably in the range of 80° C. to 130° C., in an amount in the range of 20 parts by mass to 45 parts by mass, preferably in the range of 35 parts by mass to 45 parts by mass, more preferably in the range of 35 parts by mass to 40 parts by mass per 100 parts by mass of the primary amine. Addition of the primary amine in the form of a diluted solution also allows the mixing after addition to proceed quickly.

Consequently, it is desirable to achieve a state in which the reaction liquid of the step iii contains the hydrocarbon solvent having a boiling point preferably in the range of 65° C. to 155° C., more preferably in the range of 80° C. to 130° C. in a total amount in the range of 385 parts by mass to 545 parts by mass, preferably in the range of 435 parts by mass to 540 parts by mass, more preferably in the range of 450 parts by mass to 540 parts by mass, per 100 parts by mass of the powdery silver(I) oxide as a raw material.

In the step iii, after the diluted solution of the primary amine (R—NH₂) is added, the reaction is carried out while the reaction liquid is stirred to avoid the ununiformity in the liquid temperature and in the concentration of the primary amine (R—NH₂) in the reaction liquid.

In the step iii, the decompositional reduction reaction of the primary amine complex (HCOOAg:NH₂—R) of the silver(I) formate homogeneously dissolved in the hydrocarbon solvent is used to form silver nanoparticles. Thus, it is possible to reduce variation in the particle diameter of the generated silver nanoparticles. The average particle size of the generated silver nanoparticles is easily adjusted within the range of 5 nm to 20 nm, under the aforementioned conditions.

In the above step iii, when the reaction is completed, in association with the decompositional reduction reaction of the primary amine complex (HCOOAg:NH₂—R) of the silver(I) formate of the above formula (iv), a ½ molar amount of formic acid (HCOOH) is consumed per 1 molar amount of the silver cation contained in the powdery silver(I) oxide as the raw material. In the reaction liquid, preferably, the primary amine addition salt of formic acid which is generated in the reaction of the formula (iii) and the unreacted primary amine are remaining.

On the surface of generated silver nanoparticles, a coating agent molecule layer constituted by the primary amine is formed. The amine in the layer is in equilibrium with the unreacted primary amine dissolved in the reaction liquid. The total amount of the primary amine forming this coating agent molecule layer and the unreacted primary amine dissolved in the reaction liquid preferably exceeds a ½ molar amount per 1 molar amount of the silver cations contained in the powdery silver(I) oxide as the raw material.

In the present invention, in order to recover the prepared silver nanoparticles from the reaction liquid, it is preferable to employ an embodiment in which the step A further includes the following steps iv to vi after the step iii. Specifically, it is desirable to prepare a dispersion liquid of silver nanoparticles that contains silver nanoparticles, on the surface of which the coating agent molecule layer including the primary amine is formed, and an appropriate amount of the primary amine necessary for maintaining the coating agent molecule layer including the primary amine, by removing the primary amine addition salt of the formic acid formed in the reaction of the formula (iii) and the major portion of the unreacted primary amine.

(Step iv) Removal of Hydrocarbon Solvent:

The reaction liquid is stirred during the reaction of the step iii. After bubbling which is caused by the decompositional reduction reaction of the formula (iv) is no longer observed, stirring is stopped when the liquid temperature decreases to 40° C.

The hydrocarbon solvent having preferably a boiling point in the range of 65° C. to 155° C., more preferably a boiling point in the range of 80° C. to 130° C. is distilled off under reduced pressure, the hydrocarbon solvent being contained in the reaction liquid containing the silver nanoparticles having an average particle size of 5 nm to 20 nm, the surface of the silver nanoparticles being coated with the primary amine.

In the reaction liquid, the primary amine addition salt of the formic acid and the unreacted primary amine are dissolved. The primary amine addition salt of the formic acid has a boiling point higher than the boiling point of the primary amine. The primary amine has a boiling point of 170° C. or more, and thus, does not boil and dissipate in the process of distilling off the hydrocarbon solvent having preferably a boiling point in the range of 65° C. to 155° C., more preferably in the range of 80° C. to 130° C. under reduced pressure. Accordingly, recovered is a residue which contains the remaining primary amine, the primary amine addition salt of the formic acid and the silver nanoparticles having an average particle size of 5 nm to 20 nm, the surface of the silver nanoparticles being coated with the primary amine.

(Step v) Removal of Primary Amine Addition Salt of Formic Acid and Unnecessary Primary Amine:

Methanol in an amount selected in the range of 200 parts by mass to 300 parts by mass, more preferably 200 parts by mass to 270 parts by mass and distilled water in an amount selected in the range of 50 parts by mass to 300 parts by mass, preferably in the range of 200 parts by mass to 300 parts by mass, more preferably in the range of 200 parts by mass to 270 parts by mass are added, per 100 parts by mass of the powdery silver(I) oxide as the raw material, to the residue recovered in the step iv.

The primary amine addition salt of the formic acid and the primary amine are dissolved in the mixed solvent of methanol and distilled water. Specifically, methanol contained in the mixed solvent solvates these compounds. The solvating methanol is highly compatible with water, and thus it is possible to dissolve the primary amine addition salt of the formic acid and the primary amine in this aqueous mixed solvent. In contrast, although methanol solvates the primary amine constituting the coating agent molecule layer, the silver nanoparticles, on the surface of which a coating agent molecule layer including the primary amine is formed, do not achieve compatibility necessary for being dispersed in the aqueous mixed solvent because the total size of the silver nanoparticles is 5 nm to 20 nm as an average particle size.

Accordingly, the silver nanoparticles, on the surface of which a coating agent molecule layer including the primary amine is formed, cannot be dispersed in the aqueous mixed solvent, and therefore, form a layer of precipitate. Meanwhile, the primary amine addition salt of the formic acid and the primary amine are dissolved in the aqueous mixed solvent to form a liquid phase layer. Thus, these layers are separated into a liquid phase layer/a precipitate layer.

The separated liquid phase layer is removed to recover the precipitate layer. Specifically, the supernatant portion is removed by decantation to recover the precipitate layer impregnated with the aqueous mixed solvent. Due to the difference in the solubility between the primary amine addition salt of the formic acid and the primary amine with respect to the mixed solvent of methanol and distilled water, a slight amount of the primary amine, in addition to the coating agent molecule layer including the primary amine, is adhering to the coating agent molecule layer on the surface of the silver nanoparticles contained in the precipitate layer.

(Step vi) Redispersion of Silver Nanoparticles

The silver nanoparticles, on the surface of which the coating agent molecule layer including the primary amine is formed, and which are contained in the precipitate layer recovered in the step v, are redispersed in a hydrocarbon solvent.

To the precipitate layer recovered in the step v, which is impregnated with the mixed solvent of methanol and distilled water, an appropriate amount of a hydrocarbon solvent having a boiling point preferably in the range of 65° C. to 155° C., more preferably in range of 80° C. to 130° C. is added so as to redisperse the silver nanoparticles, on the surface of which the coating agent molecule layer including the primary amine is formed, into the chain hydrocarbon solvent.

Specifically, the amount of the hydrocarbon solvent used for the redispersion is selected in the range of 100 parts by mass to 200 parts by mass, more preferably in the range of 120 parts by mass to 180 parts by mass per 100 parts by mass of the powdery silver(I) oxide as the raw material. The silver nanoparticles, on the surface of which the coating agent molecule layer including the primary amine is formed, are dispersed in the hydrocarbon solvent because the atomic group R of the primary amine (R—NH₂) has the aliphatic hydrocarbon chain having compatibility with the hydrocarbon solvent. The major portion of the primary amine remaining in the precipitate layer dissolves in the hydrocarbon solvent.

The aqueous mixed solvent has poor compatibility with hydrocarbon solvents. Therefore, the resulting liquid separates into two layers of the aqueous mixed solvent and the hydrocarbon solvent. The layer of the mixed solvent (aqueous mixed solvent) of methanol and distilled water is removed to recover the layer of the hydrocarbon solvent.

In the recovered layer of the hydrocarbon solvent, the silver nanoparticles, on the surface of which the coating agent molecule layer including the primary amine is formed, are dispersed. At this time, a considerable portion of the primary amine (R—NH₂) remaining in the precipitate layer is dissolved in the hydrocarbon solvent as the dispersion solvent. Accordingly, in the dispersion liquid of the recovered silver nanoparticles, the primary amine (R—NH₂) dissolved in this hydrocarbon solvent and the primary amine (R—NH₂) constituting the coating agent molecule layer on the silver nanoparticle surface are in a dissociative equilibrium state.

Although water does not dissolve in the hydrocarbon solvent, methanol dissolves slightly in the hydrocarbon solvent. Thus, a slight amount of methanol is dissolved in the dispersion liquid of the silver nanoparticles. The difference in the vapor pressure between methanol and the hydrocarbon solvent is used to selectively distill methanol off under reduced pressure.

It is possible to recover the silver nanoparticles, on the surface of which the coating agent molecule layer including the primary amine is formed, in a redispersed state in an appropriate amount of the hydrocarbon solvent, by carrying out a series of recovery operations of the step iv to the step vi described above. The silver nanoparticles which is prepared by means of the aforementioned method for preparing silver nanoparticles according to the present invention have an average particle size of 5 nm to 20 nm. The silver nanoparticles have, on their surface, a coating layer including the primary amine which has an aliphatic hydrocarbon chain compatibile with the hydrocarbon solvent. Therefore, the silver nanoparticles are usually stored in the form of a dispersion liquid in the hydrocarbon solvent.

The prepared redispersion liquid of the silver nanoparticles contains the hydrocarbon solvent, the primary amine, and the silver nanoparticles, on the surface of which the coating agent molecule layer including the primary amine is formed. At this time, the liquid desirably contains the primary amine in total in an amount in the range of 20 parts by mass to 30 parts by mass, more preferably in the range of 22 parts by mass to 30 parts by mass per 100 parts by mass of the silver nanoparticles. It is also desirable for the liquid to contain the hydrocarbon solvent as the dispersion solvent in an amount in the range of 100 parts by mass to 200 parts by mass, more preferably the range of 120 parts by mass to 180 parts by mass per 100 parts by mass of the silver nanoparticles.

It is possible to prepare an electro-conductive paste in accordance with the following procedure, by using the dispersion liquid of the silver nanoparticles obtained from the step A, preferably the redispersion liquid of the silver nanoparticles obtained from the step vi.

(Step B, Electro-Conductive Paste)

In the step B, to the silver nanoparticle dispersion liquid prepared in the step A, one or more metal compounds selected from the group consisting of a titanium compound and a manganese compound are added. From the step B, an electro-conductive paste can be obtained. To the silver nanoparticle dispersion liquid, other solvent(s) (solvents other than the solvent contained in the silver nanoparticle dispersion liquid) may be added appropriately. Alternatively, a portion or all of the solvent contained in the silver nanoparticle dispersion liquid may be replaced by other solvent(s).

As the titanium compound, one or more selected from the group consisting of alkoxy titanium, carboxy titanium, and titanium acetyl acetonate can be used.

Examples of the titanium compound can include titanium tetraisopropoxide and titanium tetrakis(2-ethylhexanoate).

As the manganese compound, one or more selected from the group consisting of carboxy manganese and manganese acetyl acetonate can be used.

Examples of the manganese compound can include manganese 2-ethylhexanoate and manganese(III) acetyl acetonate.

From the viewpoint of adhesion to ITO, the amount of the metal contained in the metal compound added in the step B is more than 0 parts by mass and 2.0 parts by mass or less, preferably 0.5 to 2.0 parts by mass based on 100 parts by mass of silver contained in the dispersion liquid of the silver nanoparticles obtained from the step A.

The dispersion solvent for the redispersion liquid of the silver nanoparticles is a hydrocarbon solvent having a boiling point preferably in the range of 65° C. to 155° C. It is possible to prepare an electro-conductive paste by replacing this hydrocarbon solvent by a high-boiling-point hydrocarbon solvent having a boiling point in the range of 180° C. to 310° C., preferably in the range of 200° C. to 310° C., more preferably in the range of 210° C. to 310° C.

Examples of the high-boiling-point hydrocarbon solvent that can be used include alkanes having 12 to 16 carbon atoms such as tetradecane (boiling point: 253.6° C.), and mixed solvents of naphthene/paraffin-based hydrocarbon such as AF7 Solvent (product name, boiling point: 275 to 306° C.) manufactured by Nippon Oil Corporation and IP Solvent 2028 (product name, boiling point: 213 to 262° C.) manufactured by Idemitsu Kosan Co., Ltd. Mixtures of a plurality of high-boiling-point hydrocarbon solvents also can be used.

The high-boiling-point hydrocarbon solvent is added in an amount preferably in the range of 43 parts by mass to 58 parts by mass, more preferably in the range of 45 parts by mass to 55 parts by mass per 100 parts by mass of the silver nanoparticles contained in the redispersion liquid of the silver nanoparticles. Subsequently, the difference in the vapor pressure between the hydrocarbon solvent and the high-boiling-point hydrocarbon solvent is used to selectively distill the hydrocarbon solvent off under reduced pressure.

As a result, there is prepared an electro-conductive paste including silver nanoparticles, on the surface of which the coating agent molecule layer including the primary amine is formed, homogeneously dispersed in the high-boiling-point hydrocarbon solvent.

The prepared electro-conductive paste includes the high-boiling-point hydrocarbon solvent, the primary amine, and the silver nanoparticles, on the surface of which the coating agent molecule layer including the primary amine is formed. In this case, the electro-conductive paste desirably contains the primary amine in a total amount in the range of 20 parts by mass to 30 parts by mass, preferably in the range of 22 parts by mass to 30 parts by mass per 100 parts by mass of the silver nanoparticles. It is also desirable for the paste to contain the high-boiling-point hydrocarbon solvent in an amount in the range of 43 parts by mass to 58 parts by mass, preferably in the range of 45 parts by mass to 55 parts by mass per 100 parts by mass of the silver nanoparticles.

When the prepared electro-conductive paste is used for inkjet printing, it is desirable to adjust the volume content of the silver nanoparticles in the electro-conductive paste within the range of 8% by volume to 12% by volume. That is, it is desirable to maintain a homogeneously dispersed state of the silver nanoparticles which is contained in liquid droplets to be applied by an inkjet method, by selecting the aforementioned volume content.

Additionally, the prepared electro-conductive paste can be applied to inkjet printing by adjusting the viscosity of the electro-conductive paste within the range of 8 mPa·s to 20 mPa·s (20° C.), preferably within the range of 8 mPa·s to 15 mPa·s (20° C.).

With respect to the electro-conductive paste to be applied, the film thickness distribution of the applied liquid film is determined depending on the average density of the dispersion liquid, the wettability of the dispersion solvent used, and the surface tension of the solvent. In order to adjust the wettability and the surface tension of the dispersion solvent, mixing two or more solvents each having different wettability and surface tension is effective.

The dispersibility of the silver nanoparticles, on the surface of which the coating agent molecule layer including the primary amine is formed, depends on the compatibility of the aliphatic hydrocarbon chain present in the atomic group R of the primary amine (R—NH₂) with the dispersion solvent. When the dispersibility of the silver nanoparticles is adjusted, two or more solvents may be mixed, in consideration of the wettability and the surface tension of the dispersion solvent, and furthermore, the compatibility with the primary amine (R—NH₂).

After the application of the electro-conductive paste, when the paste is heated to the range of 120° C. to 150° C., the primary amine (R—NH₂) constituting the coating agent molecule layer on the silver nanoparticle surface is dissolved out into the dispersion solvent. As a result, the silver nanoparticles settle down. The metal surfaces of the silver nanoparticles come in direct contact with each other, and thus, low-temperature sintering proceeds. Eventually, there is formed an electro-conductive coating film including the low-temperature-sintered silver nanoparticles.

(Materials Added in Step iii)

In the step iii, the primary amine is added to the dispersion liquid of the powdery silver(I) formate. In this case, a secondary amine may be added together with the primary amine. The molecular weight of the secondary amine in this case is preferably 100 or more and 150 or less. The secondary amine preferably has an aliphatic hydrocarbon chain having compatibility with the hydrocarbon solvent.

Also in the step iii, addition of the primary amine to the dispersion liquid of the powdery silver(I) formate may be carried out in the presence of a monocarboxylic acid. In this case, monocarboxylic acids having 8 to 11 carbon atoms are preferred.

For example, in the step iii, per 1 molar amount of the silver cation contained in silver(I) formate, a monocarboxylic acid can be used in a range of 0.05 molar amount to 0.3 molar amount, the primary amine can be used in a range of 0.05 molar amount to 0.3 molar amount, and the secondary amine can be used such that the total molar amount of the primary amine and the secondary amine comes within the range of 1.1 molar amount to 1.5 molar amount.

### EXAMPLES

The present invention will be described in more detail hereinbelow based on Examples, but the present invention is not restricted thereby.

### Example 1

### Step A

First, a silver nanoparticle dispersion liquid was prepared in the step A.

### Step i

Dispersed was 100 parts by mass (0.43 parts by mole) of powdery silver(I) oxide (Ag₂O, formula weight: 231.735) in 550 parts by mass of methylcyclohexane (boiling point: 100.9° C., density: 0.7737).

### Step ii

To the obtained dispersion liquid, 50 parts by mass (1.09 parts by mole) of formic acid (HCOOH, formula weight: 46.03, boiling point: 100.75° C.) was added dropwise over 3 to 5 minutes under stirring at room temperature (25° C.). Due to the addition of the formic acid, an exothermic reaction proceeded, and the liquid temperature rose to around 45° C. When the powdery silver oxide was converted to silver formate, the temperature of reaction liquid dropped thereafter.

### Step iii

When the temperature of the obtained reaction liquid dropped to 27° C. or less, a solution of 230 parts by mass of 2-ethylhexyloxypropylamine (C₁₁H₂₅NO, formula weight: 187.32, boiling point: 235° C.) dissolved in 50 parts by mass of methylcyclohexane was added to the reaction liquid.

Due to an acid-base neutralization reaction which was caused by the addition of the amine, the liquid temperature rose to around 65° C. As the liquid temperature rises, a decompositional reduction reaction of silver formate via an amine complex of silver formate occurs. Silver nanoparticles which are precipitated by the reduction reaction are protected by the primary amine (2-ethylhexyloxypropylamine) in the system. After the liquid temperature rose to around 65° C., the stirring of the reaction liquid was continued, and when the liquid temperature dropped to 45° C., the stirring was stopped.

### Step iv

The obtained navy-blue dispersion liquid was transferred to an eggplant flask, and then diisopropylamine and methylcyclohexane as the reaction solvent were distilled off under reduced pressure. The contents containing the silver nanoparticles in the eggplant flask turned into the form of slurry form because the solvent and the like were removed.

### Step v

To the residue, after removing the solvent, 280 parts by mass of methanol (boiling point: 64.7° C.) and 50 parts by mass of distilled water were added.

In the mixed solvent containing methanol and distilled water, a diisoropylamine addition salt of formic acid or neodecanoic acid, a 2-ethylhexyloxypropylamine addition salt of formic acid or neodecanoic acid, and methylcyclohexane are dissolved. On the other hand, silver nanoparticles settle down without dispersing in the hydrous methanol.

The supernatant phase of the mixed solvent (hydrous methanol) was removed by decantation.

In order to improve the efficiency of removing the remaining components, 280 parts by mass of methanol was further added to the settled phase which was obtained from the decantation, and the resulting mixture was stirred. Then, the supernatant phase was removed by decantation.

### Step vi

To the settled phase obtained from the decantation, 120 parts by mass of heptane was added. The settled silver nanoparticles were dispersed in methylcyclohexane. Methanol which had remained in the settled silver particles was phase-separated due to its poor compatibility with heptane. The phase-separated methanol phase (hydrous methanol) portion was removed.

### Purification Step

In the heptane layer in which the silver nanoparticles were dispersed, a slight amount of methanol was contained as an impure ingredient. The contained methanol was distilled off under reduced pressure. The difference in the boiling point between methanol and heptane was used to selectively distill methanol off. Specifically, methanol was removed at 45° C. (bath temperature) and 150 hPa for 5 minutes. Then, the degree of the pressure reduction was raised to 120 hPa, and methanol was further removed for 3 minutes.

The heptane liquid in which the obtained silver nanoparticles were dispersed was filtered with a 0.2 μm membrane filter to remove aggregates. As the filtrate obtained from the filtration, a silver nanoparticle dispersion liquid was obtained.

### Evaluation on Silver Nanoparticle Dispersion Liquid

The total amount of metal silver which was contained in the obtained silver nanoparticle dispersion liquid was measured, and the yield was calculated based on the content of silver which was contained silver(I) oxide as the starting material. The calculated yield was 98%.

A method for measuring the total amount of metal silver is as follows. The obtained silver nanoparticle dispersion liquid was weighed into a crucible, and methylcyclohexane which was contained in the liquid was dried off to obtain a solid, by using a hot-air dryer. Then, the crucible was placed in a muffle furnace and fired at 700° C. for 30 minutes. After the firing, only metal remained, and thus, the metal amount was weighed. From the concentration of the dispersion liquid, the total amount of metal silver was calculated.

Additionally, the obtained silver nanoparticle dispersion liquid was left to stand at room temperature for a week, and then the settlement of particles was visually checked. Settlement of particles was not observed.

The particle diameter of the silver nanoparticles dispersed in the obtained silver nanoparticle dispersion liquid was measured by use of a light scattering particle size analyzer (manufactured by MicrotracBEL Corp., product name: Nanotrac UPA150). From the measurement results, it was found that the average particle size of the silver nanoparticles which were homogeneously dispersed in the filtrate was 9 nm.

In the obtained silver nanoparticle dispersion liquid, the surface of the silver nanoparticles was coated with 25.0 parts by mass of 2-ethylhexyloxypropylamine per 100 parts by mass of the silver nanoparticles which were coated with 2-ethylhexyloxypropylamine (100 parts by mass as the mass of silver only, not containing the coating agent).

A method for measuring the amount of the coating agent with which the silver nanoparticles were coated is as follows. That is, about 0.1 g of the dispersion liquid in which silver nanoparticles were dispersed in heptane was weighed in a glass bottle, and the solvent content was dried by means of a dryer (cold air) into a powder form. About 10 mg of the dry powder was heated to 500° C. in a thermal analyzer (product name: TG/DTA6200, manufactured by SII NanoTechnology Inc.) to be analyzed. The amount of the coating agent was calculated from the weight reduction ratio.

### Step B

The silver nanoparticle dispersion liquid which was obtained in the step A was used in such an amount that the amount of silver which was contained in the dispersion liquid reached 60 parts by mass. Into this dispersion liquid, 38.2 parts by mass of tetradecane (boiling point: 253.6° C., density: 0.7624 g/cm³) and 1.8 parts by mass of titanium tetraisopropoxide (manufactured by Wako Pure Chemical Industries, Ltd.) were mixed.

Heptane which was contained in the obtained liquid mixture was distilled off under reduced pressure to prepare ink (electro-conductive paste for printing) including tetradecane as the dispersion solvent. The amount of metal titanium contained in the ink was 0.5 parts by mass with respect to 100 parts by mass of silver.

The viscosity of the produced ink was 11 m·Pas (20° C.), and the metal content was 55.2% by mass. The prepared electro-conductive ink was applied by spin coating to ITO-coated glass having a width of 25 mm and a length of 75 mm. The average film thickness of the applied coating film was 6 μm. The silver nanoparticles were sintered by heat-treating the obtained coating film in the atmosphere at 200° C. for 60 minutes using an air drying furnace. The resistivity of the produced low-temperature fired film of the silver nanoparticles was measured. The film thickness after the firing was 0.9 μm, and the resistivity of the low-temperature fired film was 13 μΩ·cm. With respect to adhesion of the fired film to the ITO-coated glass, a cross cut test was carried out to check the presence of peel-off for 81 squares, each square having a size of 1 mm×1 mm. No peel-off was observed in all squares.

### Examples 2 to 9, and Comparative Examples 1 to 3

Preparation and evaluation of an electro-conductive paste were carried out in the same manner as in Example 1 except that electro-conductive paste formulations shown in Table 1 were each employed in the step B. The results are shown in Table 1. Note that, for instance, titanium(IV) 2-ethylhexanolate was used as the metal compound in Example 4. In Examples 5 to 7, for instance, manganese 2-ethylhexanoate solution in mineral spirits (manufactured by Wako Pure Chemical Industries, Ltd., Mn: 8% by mass) is used in order to add a metal compound.

In Comparative Example 1, no metal compound was added to the electro-conductive paste. In Comparative Example 1, peeling-off occurred in 40 squares out of a total 81 squares, each square having a size of 1 mm×1 mm, in the cross cut test.

In each of Comparative Examples 2 and 3, when the electro-conductive paste was fired, cracks occurred. Thus, it was not possible to measure the conductivity and the film thickness after the firing.

TABLE 1

| | | | | | | | | | | | | Comparative | | |
|---|---|---|---|---|---|---|---|---|---|---|---|---|---|---|
| | | | Example | | | | | | | | | Example | | |
| | | | 1 | 2 | 3 | 4 | 5 | 6 | 7 | 8 | 9 | 1 | 2 | 3 |
| Paste formulation | Silver | | 60 | 60 | 60 | 60 | 60 | 60 | 60 | 60 | 60 | 60 | 60 | 60 |
| | nanoparticles | | | | | | | | | | | | | |
| | (in the silver | | | | | | | | | | | | | |
| | nanoparticle | | | | | | | | | | | | | |
| | dispersion | | | | | | | | | | | | | |
| | obtained from | | | | | | | | | | | | | |
| | step A) | | | | | | | | | | | | | |
| | Tetradecane | | 38.2 | 36.4 | 32.8 | 36.46 | 36.2 | 32.4 | 24.8 | 38.93 | 37.75 | 40 | 31.1 | 21.25 |
| | Titanium | Molecular weight: | 1.8 | 3.6 | 7.2 | | | | | 1.07 | | | 8.9 | |
| | tetraisopropoxide | 284.22 | | | | | | | | | | | | |
| | | (Ti content: 16.84% by | | | | | | | | | | | | |
| | | mass) | | | | | | | | | | | | |
| | Titanium(IV) 2- | Molecular weight: | | | | 3.54 | | | | | 2.25 | | | 18.75 |
| | ethylhexanolate | 564.75 | | | | | | | | | | | | |
| | | (Ti content: 8.47% by | | | | | | | | | | | | |
| | | mass) | | | | | | | | | | | | |
| | Manganese(II) 2- | Mn content: | | | | | 3.8 | 7.6 | 15.2 | | | | | |
| | ethylhexanoate | 8% by mass | | | | | | | | | | | | |
| | Solution in mineral | | | | | | | | | | | | | |
| | spirits | | | | | | | | | | | | | |
| | Proportion of | | 0.5% | 1.0% | 2.0% | 0.5% | | | | 0.3% | | | 2.5% | |
| | Ti to Ag | | | | | | | | | | | | | |
| | Proportion of | | | | | | 0.5% | 1.0% | 2.0% | | 0.3% | | | 2.5% |
| | Mn to Ag | | | | | | | | | | | | | |
| Paste evaluation | Metal content | 700° C., 30 min | 55.2 | 55.8 | 56 | 55.4 | 56.2 | 57 | 56.8 | 54.8 | 57.1 | 55.7 | 56 | 57.2 |
| | (% by mass) | | | | | | | | | | | | | |
| | Viscosity (mPa · s) | 20° C., 60 rpm | 11 | 13 | 19 | 14 | 10 | 12 | 18 | 11 | 9 | 10 | 24 | 20 |
| | Conductivity | Air drying furnace, | 13 | 25 | 37 | 17 | 24 | 38 | 56 | 12 | 16 | 3.6 | *1 | *1 |
| | (μΩ · cm) | 200° C. 1 hr | | | | | | | | | | | | |
| | Film thickness | | 0.9 | 1 | 1.3 | 1.0 | 0.8 | 0.9 | 1.1 | 0.9 | 0.8 | 1.0 | | |
| | after firing (μm) | | | | | | | | | | | | | |
| | Cross cut test | Proportion of the | 0 | 0 | 0 | 0 | 0 | 0 | 0 | 30 | 20 | 50 | 0 | 0 |
| | (peeled-off %) | number of peeled-off | | | | | | | | | | | | |
| | | Squares out of all the | | | | | | | | | | | | |
| | | 81 Squares | | | | | | | | | | | | |

*1: Not measurable due to occurrence of cracks

### INDUSTRIAL APPLICABILITY

The silver nanoparticles prepared by the present invention can be suitably used for mounting electronic components on an ITO film or glass or for forming wiring on an ITO film or glass, for example.

1. A method for producing an electro-conductive paste comprising:
A) a step of preparing silver nanoparticles having an average particle size of 5 nm to 20 nm, the silver nanoparticles having a coating layer comprising coating agent molecules on the surface,
the step of preparing silver nanoparticles being a step in which powdery silver(I) oxide is used as a raw material, in a liquid phase, formic acid is allowed to react with the powdery silver(I) oxide to convert the powdery silver(I) oxide into silver(I) formate, silver cations contained in the silver(I) formate are reduced to silver atoms, and the silver nanoparticles are prepared from the silver atoms; and
the step of preparing silver nanoparticles comprising
Step i:
a step of preparing a dispersion liquid of the powdery silver(I) oxide using a hydrocarbon solvent;
Step ii:
a step of adding formic acid to the dispersion liquid of the powdery silver(I) oxide to allow formic acid to react with the powdery silver(I) oxide to thereby convert the powdery silver(I) oxide into silver(I) formate, and
preparing a dispersion liquid of powdery silver(I) formate containing powder of silver(I) formate formed in the hydrocarbon solvent; and
Step iii:
a step of adding a primary amine to the dispersion liquid of the powdery silver(I) formate to allow the primary amine to react with the powdery silver(I) formate to thereby form a primary amine complex of the silver(I) formate,
dissolving the formed primary amine complex of the silver(I) formate in the hydrocarbon solvent, and then,
forming silver nanoparticles having an average particle size of 5 nm to 20 nm comprising silver atoms by a decompositional reduction reaction of the primary amine complex of the silver(I) formate,
wherein the silver nanoparticles having an average particle size of 5 nm to 20 nm formed in the step iii have a structure in which silver atoms on the surface of the silver nanoparticles are coated with the primary amine via coordination bonding by means of the lone electron pair present on the amino nitrogen atom of the primary amine; and
B) a step of adding one or more metal compounds selected from the group consisting of a titanium compound and a manganese compound to the dispersion liquid of the silver nanoparticles obtained from the step A, metal contained in the metal compound being in an amount of more than 0 part by mass and 2.0 parts by mass or less based on 100 parts by mass of silver contained in the dispersion of the silver nanoparticles obtained from the step A.

2. The method according to claim 1, wherein the titanium compound is one or more selected from the group consisting of alkoxy titanium, carboxy titanium, and titanium acetyl acetonate and the manganese compound is one or more selected from the group consisting of carboxy manganese and manganese acetyl acetonate.

3. The method according to claim 1, wherein the amount of the metal contained in the metal compound added in the step B is 0.5 to 2 parts by mass based on 100 parts by mass of silver contained in the dispersion liquid of the silver nanoparticles obtained from the step A.

4. The method according to claim 1, wherein the hydrocarbon solvent used in the step i is a hydrocarbon solvent having a boiling point in the range of 65° C. to 155° C. in an amount selected in the range of 350 parts by mass to 550 parts by mass per 100 parts by mass of the powdery silver(I) oxide as the raw material.

5. The method according to claim 1, wherein the hydrocarbon solvent used in the step i is a hydrocarbon having 6 to 9 carbon atoms.

6. The method according to claim 1, wherein the amount of the formic acid used in step ii is selected in the range of 1.1 molar amount to 1.4 molar amount per 1 molar amount of the silver cation contained in the powdery silver(I) oxide as the raw material.

7. The method according to claim 1, wherein a monocarboxylic acid having 8 to 11 carbon atoms is added in the step iii.

8. The method according to claim 1, wherein a primary amine having 9 to 11 carbon atoms is used as the primary amine and a secondary amine is added in the step iii.

9. The method according to claim 1, wherein the primary amine used in the step iii is a primary amine (R—NH₂) comprising an amino group and an atomic group R having an aliphatic hydrocarbon chain having compatibility with the hydrocarbon solvent, the amount of the primary amine being selected in the range of 1.2 molar amount to 1.8 molar amount per 1 molar amount of the silver cation contained in the powdery silver(I) oxide as the raw material.

10. The method according to claim 9, wherein, in the primary amine (R—NH₂) comprising the amino group and the atomic group R having the aliphatic hydrocarbon chain having compatibility with the hydrocarbon solvent,
the atomic group R having an aliphatic hydrocarbon chain having compatibility with the hydrocarbon solvent is selected from
an (alkyloxy)alkyl group, an (alkylamino)alkyl group, a (dialkylamino)alkyl group and an alkyl group having 7 to 12 carbon atoms in total.

11. The method according to claim 9, wherein the primary amine (R—NH₂) comprising the amino group and the atomic group R having the aliphatic hydrocarbon chain having compatibility with the hydrocarbon solvent is an amine compound having a boiling point more than 170° C.

12. The method according to claim 11, wherein the primary amine (R—NH₂) comprising the amino group and the atomic group R having the aliphatic hydrocarbon chain having compatibility with the hydrocarbon solvent is an amine compound having a boiling point in the range of 200° C. to 270° C.

13. The method according to claim 9, wherein the primary amine (R—NH₂) comprising the amino group and the atomic group R having the aliphatic hydrocarbon chain having compatibility with the hydrocarbon solvent is 3-alkyloxypropylamine (R′—O—CH₂CH₂CH₂—NH₂), and
the alkyl group (R′) constituting the alkyloxy atomic group (R′—O—) is an alkyl group having 4 to 9 carbon atoms.

14. The method according to claim 1, wherein
in the step iii,
a primary amine (R—NH₂) comprising an amino group and an atomic group R having an aliphatic hydrocarbon chain having compatibility with the hydrocarbon solvent is diluted using the hydrocarbon solvent to provide a diluted solution, which is then added to the dispersion liquid of the powdery silver(I) formate, and
the diluted solution is subjected to the dilution by adding the hydrocarbon solvent in an amount in the range of 20 parts by mass to 45 parts by mass per 100 parts by mass of the primary amine.

15. The method according to claim 1, wherein
in the step iii,
in parallel with the reaction in which the primary amine reacts with the powdery silver(I) formate to form the primary amine complex of the silver(I) formate,
there proceeds a reaction in which the added primary amine reacts with residual formic acid that has not been consumed in the reaction with the powdery silver(I) oxide in the step ii, to form a primary amine addition salt of the formic acid, and
the liquid temperature is raised by reaction heat ascribed to the reaction of forming the primary amine addition salt of the formic acid.

16. The method according to claim 1, wherein
the step A further comprises the following step iv to step vi after the step iii:
Step iv:
a step of distilling the hydrocarbon solvent off under reduced pressure after the step iii is finished, the hydrocarbon solvent being contained in the reaction liquid containing the silver nanoparticles having an average particle size of 5 nm to 20 nm, the surface of the silver nanoparticles being coated with the primary amine, and
recovering a residue containing residual primary amine, a primary amine addition salt of the formic acid, and the silver nanoparticles having an average particle size of 5 nm to 20 nm, the surface of the silver nanoparticles being coated with the primary amine;
Step v:
a step of adding to the residue recovered in the step iv methanol in an amount selected in the range of 200 parts by mass to 300 parts by mass and distilled water in an amount selected in the range of 50 parts by mass to 300 parts by mass per 100 parts by mass of the powdery silver(I) oxide as the raw material,
dissolving the primary amine addition salt of the formic acid and the residual primary amine contained in the residue in the mixed solvent of methanol and distilled water,
separating a resulting mixture into a precipitate layer containing the silver nanoparticles having an average particle size of 5 nm to 20 nm, the surface of the silver nanoparticles being coated with the primary amine, and a liquid phase layer containing the primary amine addition salt of the formic acid and primary amine dissolved in the mixed solvent, and
removing the liquid phase layer containing the primary amine addition salt of the formic acid and the primary amine dissolved in the mixed solvent to recover a precipitate layer containing the silver nanoparticles having an average particle size of 5 nm to 20 nm, the surface of the silver nanoparticles being coated with the primary amine;
Step vi:
a step of adding a hydrocarbon solvent having a boiling point in the range of 65° C. to 155° C. in an amount selected in the range of 100 parts by mass to 200 parts by mass per 100 parts by mass of the powdery silver(I) oxide as the raw material to the precipitate layer recovered in the step v,
homogeneously dispersing the silver nanoparticles having an average particle size of 5 nm to 20 nm, the surface of the silver nanoparticles being coated with the primary amine, contained in the precipitate layer in the hydrocarbon solvent having a boiling point in the range of 65° C. to 155° C. to obtain a dispersion liquid,
separating this dispersion liquid into a layer of a small amount of the mixed solvent of methanol and distilled water with which the precipitate layer has been impregnated and a layer of a dispersion liquid containing the hydrocarbon solvent having a boiling point in the range of 65° C. to 155° C. as a dispersion solvent, and
removing the layer of the small amount of the mixed solvent of methanol and distilled water to recover the layer of the dispersion liquid containing the hydrocarbon solvent having a boiling point in the range of 65° C. to 155° C. as the dispersion solvent.
